(19) United States
(12) Patent Application Publication
(10) Pub. No.: US 2025/0171637 A1
(43) Pub. Date: May 29, 2025

(54) RAPID LOW TEMPERATURE CURING MOLDABLE SILICONE COMPOSITIONS

(71) Applicants: Rohm and Haas Company, Collegeville, PA (US); Dow Silicones Corporation, Midland, MI (US)

(72) Inventors: Andrew Shah, Conshohocken, PA (US); Zhanjie Li, Midland, MI (US); Jason Suhr, Coleman, MI (US)

(21) Appl. No.: 18/844,086

(22) PCT Filed: Feb. 13, 2023
(86) PCT No.: PCT/US2023/012907

§ 371 Date: Sep. 5, 2024

Related U.S. Application Data
(60) Provisional application No. 63/324,178, filed on Mar. 28, 2022.

(51) Int. Cl. C08L 83/06

(52) U.S. Cl. CPC C08L 83/06; C08L 2205/025; C08L 2312/08

(57) ABSTRACT

A two-part curable silicone composition contains as separate parts: (a) a first part with an alkenyl-functional prepolymer that is a hydrosilylation reaction product of a first part pre-mixture containing a platinum hydrosilylation catalyst, alkenyl-functional linear polyorganosiloxanes, alkenyl-functional resinous polyorganosiloxanes, and a linear SiH functional chain extender; and (b) a second part with a linear alkenyl-functional polyorganosiloxane, a resinous alkenyl-functional polyorganosiloxane, a resinous SiH functional polyorganosiloxane crosslinker, and a hydrosilylation cure inhibitor; wherein the alkenyl-functional and SiH functional components are present in the two-part curable silicone composition so as to provide a SiH/C═C ratio that is 1.4 or less; and wherein the composition contains 6 weight part per million or less of platinum and 0.01 weight-percent or more hydrosilylation cure inhibitor, with concentrations based on the combined weight of the first and second parts.

### FIELD OF THE INVENTION

The present invention relates to a two-part curable moldable silicone composition.

### Introduction

Optical moldable silicone compositions are useful for example in making automotive headlamps. However, optical moldable silicone compositions typically require curing at temperatures in a range of 150 degrees Celsius (° C.) or higher. It is desirable to identify an optical moldable silicone composition that can be cured at temperatures of 110° C. or lower so that other polymers such as polycarbonate can be used without having to heat above their melting temperature in co-molding processes. In particular, it is desirably to achieve “rapid” curing at temperature of 110° C. or lower where “rapid” and related terms with respect to curing is defined as achieving a viscosity of one deciNewton*meter (dNm) or more in a Moving Die Rheometer test (defined herein, below) in 60 seconds or less.

Optical moldable silicone compositions can be hydrosilylation curable compositions. Curing of hydrosilylation reactions can occur at temperatures of 110° C. or lower by increasing the curing time, but that will not meet the need for rapid curing.

Other ways to approach to reducing curing time of a hydrosilylation reaction is to increase either the concentration of platinum catalyst, decreasing inhibitor concentration or increasing silicon-hydride (SiH) crosslinker concentration. However, use of platinum catalyst at a concentration providing more than 6 weight-parts per million (ppm) relative to composition weight tends to result in undesirable yellowing of a resulting reaction product over time. Decreasing inhibitor concentration below 0.01 weight-percent (wt %) relative to composition weight reduces the pot-life, or working time, of the composition and can undesirably result in premature curing during an injection molding process. Increasing the molar concentration of silylhydride groups (SiH) relative to molar concentration of alkenyl groups bound directly or indirectly to silicone (C═C) to a molar ratio (SiH/C═C ratio) above approximately 1.6 can result in optical moldable silicone compositions that are undesirably brittle over time.

Therefore, it is desirable and would advance the art of optical moldable silicone formulations to identify a moldable silicone composition that can rapidly cure by hydrosilylation at a temperature of 110° C. or less without requiring more than 6 ppm platinum based on composition weight or less than 0.01 wt % inhibitor based on composition weight, and that has a SiH/C═C ratio of less than 1.6.

### BRIEF SUMMARY OF THE INVENTION

The present invention provides a moldable silicone composition that can rapidly cure by hydrosilylation at a temperature of 110° C. or less without requiring more than 6 ppm platinum based on composition weight or less than 0.01 wt % inhibitor based on composition weight, and that has a SiH/C═C ratio of less than 1.6

The present invention is a result of discovering that the desired characteristics can be achieved with a two-part curable composition comprising a first part and a second part where:
(a) the first part is an alkenyl-functional prepolymer composition prepared by a hydrosilylation reaction of alkenyl-functional linear and alkenyl-functional resinous polyorganosiloxanes with a linear silicon-hydride (SiH) functional chain extender; and
(b) the second part comprises resinous and linear alkenyl-functional polyorganosiloxanes, a resinous SiH functional polyorganosiloxane crosslinker, and a hydrosilylation cure inhibitor.

Part of discovering the present invention was discovering the requirements for the first part of the two-part composition, particularly the characteristics around the alkenyl-functional prepolymer. For example, when the SiH functional chain extender has a degree of polymerization (DP) less than 100 then the concentration of chain extender when forming the prepolymer must be less than 5 wt % based on the combined weight of the first and second parts or the viscosity of the first part will be too high (above 50,000 milliPascal*seconds) to mix with the second part. Additionally, it has been discovered that the second part need to be free of linear polyorganosiloxanes having SiH functionality only as HMeSiO_{2/2} siloxane units because such a linear polyorganosiloxane slows curing during the first 60 seconds.

In a first aspect, the present invention is a two-part curable silicone composition comprising as separate parts: (a) a first part comprising an alkenyl-functional prepolymer that is the hydrosilylation reaction product of a first part pre-mixture comprising: (i) a platinum hydrosilylation catalyst, (ii) alkenyl-functional linear polyorganosiloxanes, (iii) alkenyl-functional resinous polyorganosiloxanes, and (iv) a linear SiH functional chain extender having an average of 2 SiH groups per molecule and being present at a concentration of 0.25 weight-percent or more and at the same time 5 weight-percent or less when having a DP of 100 or more and less than 5 weight-percent when having a DP of less than 100, with weight-percent relative to combined weight of the first and second parts; and (b) a second part comprising: (i) a linear alkenyl-functional polyorganosiloxane; (ii) a resinous alkenyl-functional polyorganosiloxane, (iii) a resinous SiH functional polyorganosiloxane crosslinker, and (iv) a hydrosilylation cure inhibitor; wherein the alkenyl-functional and SiH functional components are present in the two-part curable silicone composition so as to provide a SiH/C═C ratio for the two-part curable silicone composition that is 1.4 or less; and wherein the composition contains 6 weight part per million or less of platinum and 0.01 weight-percent or more hydrosilylation cure inhibitor, with concentrations based on the combined weight of the first and second parts.

The composition of the present invention is useful as a moldable silicone formulation that can be used as an optical moldable silicone formulation.

### DETAILED DESCRIPTION OF THE INVENTION

Test methods refer to the most recent test method as of the priority date of this document when a date is not indicated with the test method number. References to test methods contain both a reference to the testing society and the test method number. The following test method abbreviations and identifiers apply herein: ASTM refers to ASTM International methods; END refers to European Norm; DIN refers to Deutsches Institut für Normung; ISO refers to International Organization for Standards; and UL refers to Underwriters Laboratory.

Products identified by their tradename refer to the compositions available under those tradenames on the priority date of this document.

“Multiple” means two or more. “And/or” means “and, or as an alternative”. All ranges include endpoints unless otherwise indicated.

It is common to define a polysiloxane chemical composition by specifying siloxane units in the polysiloxane. There are four siloxane units used to form silicones: R^{a}₃SiO_{1/2} (“M-type” siloxane units), R^{a}₂SiO_{2/2} (“D-type” siloxane units), R^{a}SiO_{3/2} (“T-type” siloxane units) and SiO_{4/2} (“Q-type” siloxane units). In these general designations, R^{a} can be independently in each occurrence be a hydrogen, hydrocarbyl group (substituted or non-substituted), hydroxyl, alkoxyl, or essentially any other group bound to the silicon atom. The O's refer to oxygen atoms bound the silicon that are bound to a silicon atom of another siloxane unit. The subscript is a multiple of ½ to reflect that the oxygen is bound to this silicon atom and another silicon atom of another siloxane unit also having a multiple of ½ in the denominator—both siloxane units reflect ownership of ½ of the same oxygen atom. The number in the oxygen subscript reflects how many oxygens are bound to the specified silicon atom that are also bound to another siloxane unit silicon atom. Typically, there are subscripts associated with the siloxane units themselves to indicate the relative amounts of the siloxane unit in the molecule. If the subscripts associated with siloxane units are greater than one, then the subscript refers to the average number of those siloxane units in the molecule. If the subscript associated with siloxane units is less than one, then the subscript refers to the average molar ratio of all siloxane units that correspond to the associated siloxane unit. Subscripts of one are typically left unstated so if a siloxane unit does not include a subscript it is understood to have a subscript of one. Notably, the siloxane units are present in blocks but do not necessarily imply block polymerization but rather are presented in block for convenience to indicate how much of each siloxane unit is present total in the polymer.

Siloxane terminology as used herein uses the term “resin” or “resinous” to describe a siloxane that has a material level of siloxane unit branching as characterized by possessing, on average, more than three siloxane units selected from T-type, Q-type, or a combination of T-type and Q-type siloxane units in a single molecule. In contrast “linear” siloxanes contain, on average, three or fewer, preferably 2 or fewer, more preferably one or fewer, and can be free of T-type, Q-type, or a combination of T-type and Q-type siloxane units in a single molecule.

“Degree of polymerization”, or “DP”, refers to the average number of repeating siloxane units in a siloxane molecule. For example, in the following molecule the DP would be equal to the value of subscript d: ViMeSiO-[Me₂SiO]_{d}—SiMeVi. Determine DP by silicon-29 nuclear magnetic resonance (²⁹Si NMR) spectroscopy.

Determine weight-average molecular weight for resinous siloxanes by gel permeation chromatography using a light-scattering detector, a refractive index detector, and a viscosity detector along with polystyrene standards.

“SiH/C═C ratio”, or “SiH/C═C”, is the molar ratio of silyl hydride hydrogen atoms to alkenyl groups (preferably terminal alkenyl groups) bound directly or indirectly to silicon atoms. The alkenyl group is desirably a vinyl group, in which case the ratio is often identified as a SiH/SiVi ratio. Determine SiH/C═C ratio by proton nuclear magnetic resonance (¹H NMR) spectroscopy. Prepare samples for analysis by combining a known amount of sample with a known amount of an internal standard (1,4-dioxane) in deuterated chloroform. Collect spectra using an Aligent 400-MR NMR instrument equipped with a 5 millimeter ONeNMR probe. Analyze data using MesReNova x64 software. Calculate weight percentages of alkenyl (C═C) and SiH groups by integrating the relevant proton resonances against those of the internal standard.

The present invention is a two-part curable silicone composition comprising separate first and second parts. The two-part curable silicone composition comprises alkenyl-functional components in the first part and silylhydride (SiH) functional components in the second part. Upon mixing the first and second part together the alkenyl functionality and SiH functionalities in the two parts react to cure the silicone composition. The first and second parts of the two-part curable silicone composition are kept separate from one another until such time as curing of the two-part silicone composition is desired, which is what is meant by “separate first and second parts.”

The first part comprises an alkenyl-functional prepolymer component that is the hydrosilylation reaction product of a first part pre-mixture comprising: a platinum hydrosilylation catalyst, an alkenyl-functional linear polyorganosiloxanes, an alkenyl-functional resinous polyorganosiloxanes and a linear SiH functional chain extender.

The catalyst is a platinum hydrosilylation catalyst. Platinum hydrosilylation catalysts include compounds and complexes such as platinum (0)-1,3-divinyl-1,1,3,3-tetramethyldisiloxane (Karstedt's catalyst), H₂PtCl₆, di-μ-carbonyl di-π-cyclopentadienyldinickel, platinum-carbonyl complexes, platinum-divinyltetramethyldisiloxane complexes, platinum cyclovinylmethylsiloxane complexes, platinum acetylacetonate (acac), platinum black, platinum compounds such as chloroplatinic acid, chloroplatinic acid hexahydrate, a reaction product of chloroplatinic acid and a monohydric alcohol, platinum bis(ethylacetoacetate), platinum bis(acetylacetonate), platinum dichloride, and complexes of the platinum compounds with olefins or low molecular weight polyorganosiloxanes or platinum compounds microencapsulated in a matrix or core-shell type structure. The platinum catalyst can be part of a solution that includes complexes of platinum with low molecular weight polyorganosiloxanes that include 1,3-diethenyl-1,1,3,3-tetramethyldisiloxane complexes with platinum. These complexes may be microencapsulated in a resin matrix. The platinum catalyst can be 1,3-diethenyl-1,1,3,3-tetramethyldisiloxane complex with platinum.

Desirably, the platinum catalyst is present at a concentration sufficient low so as to provide 6 weight parts per million (ppm) or less platinum based on combined weight of first and second parts. Typically, the concentration of the platinum from the platinum catalyst is 2 ppm or more and can be 3 ppm or more, 4 ppm or more, or even 5 ppm or more.

The alkenyl-functional linear polyorganosiloxane desirably contains an average of 2 or more alkenyl groups per molecule. Desirably, the alkenyl-functional linear polyorganosiloxane contains two or more terminal alkenyl groups, where a terminal alkenyl group is bound to a silicon atom at the end of the linear siloxane molecule. Preferably, there is at least one alkenyl group on each end of the alkenyl-functional linear polyorganosiloxane. The alkenyl groups themselves are desirably terminal alkenyl groups, meaning the carbon-carbon double bond (C═C) is between two carbon atoms most remote from where the alkene is bound to a silicon atom. Each alkene can have 2 or more, 3 or more, 4 or more, 5 or more, even 6 or more carbon atoms and at the same time typically contains 8 or fewer, 7 or fewer, 6 or fewer, 5 or fewer, 4 or fewer, even 3 or fewer carbon atoms. Desirably, each alkene is a vinyl group (“Vi”).

The alkenyl-functional linear polyorganosiloxane can have an average chemical composition (I):

[ViMe₂SiO_{1/2}]₂[Me₂SiO_{2/2}]_{d} (I)

where Vi refers to a vinyl group, Me refers to a methyl group, subscript d is the average number of (CH₃)₂SiO_{2/2} units in the molecule and has a value of 300 or more, 350 or more, 400 or more, even 450 or more and at the same time typically 700 or less, 650 or less, 600 or less, or even 550 or less.

The concentration of alkenyl-functional linear polyorganosiloxane in the first part pre-mixture is typically 40 weight-percent (wt %) or more, 45 wt % or more, 50 wt % or more, or even 55 wt % or more while at the same time is typically 60 wt % or less, 55 wt % or less 50 wt % or less, or even 45 wt % or less relative to the combined weight of alkenyl-functional linear polyorganosiloxane and alkenyl-functional resinous polyorganosiloxanes in the first part pre-mixture.

The alkenyl-functional resinous polyorganosiloxane is a polyorganosiloxane resin, meaning it is a branched molecule that contains an average per molecule of more than three siloxane units selected from RSiO_{3/2} and SiO_{4/2} siloxane groups where R is a hydrocarbyl group that typically contains 8 or fewer, and can contain 7 or fewer, 6 or fewer, 5 or fewer, 4 or fewer, 3 or fewer, even 2 or fewer while at the same time one or more carbon atom. Desirably, the alkenyl functional resinous polyorganosiloxane contains an average of 2 or more alkenyl groups per molecule and can contain 3 or more alkenyl groups per molecule. The alkenyl groups themselves are desirably terminal alkenyl groups of an alkene bound to silicon atoms, meaning the carbon-carbon double bond (C═C) is between two carbon atoms most remote from where the alkene is bound to a silicon atom. Each alkene can have 2 or more, 3 or more, 4 or more, 5 or more, even 6 or more carbon atoms and at the same time typically contains 8 or fewer, 7 or fewer, 6 or fewer, 5 or fewer, 4 or fewer, even 3 or fewer carbon atoms. Desirably, each alkene is a vinyl group.

The alkenyl-functional resinous polyorganosiloxane can have an average chemical formula (II):

[ViMe₂SiO_{1/2}]_{m′}[Me₂SiO_{1/2}]ₘ[SiO_{4/2}]_{q}[HO_{1/2}]ₙ (II)
where Vi refers to a vinyl group, Me refers to a methyl group, subscripts refer to average mole-ratios of the associated group relative to all listed groups, m′ has a value in a range of 0.05 and 0.10, m has a value in a range of 0.40 and 0.50, q has a value in a range of 0.40 and 0.50, and n has a value in a range of 0.00 and 0.05.

The concentration of alkenyl-functional resinous polyorganosiloxane in the first part pre-mixture is typically 40 weight-percent (wt %) or more, 45 wt % or more, 50 wt % or more, or even 55 wt % or more while at the same time is typically 60 wt % or less, 55 wt % or less 50 wt % or less, or even 45 wt % or less relative to the combined weight of alkenyl-functional linear polyorganosiloxane and alkenyl-functional resinous polyorganosiloxanes in the first part pre-mixture.

Desirably, the alkenyl-functional resinous polyorganosiloxane in the first part has a weight-average molecular weight of 3000 Daltons (Da) or more, 3100 Da or more, 3200 Da or more, 3300 Da or more, 3400 Da or more, 3500 Da or more, 3600 Da or more, 3700 Da or more, 3800 Da or more, even 3900 Da or more while at the same time is typically 4000 Da or less, and can be 3900 Da or less, 3800 Da or less, 3700 Da or less, 3600 Da or less, 3500 Da or less, 3400 Da or less, 3300 Da or less, 3200 Da or less, or even 3100 Da or less.

The linear SiH functional chain extender is a polyorganosiloxane having an average of 2 SiH groups per molecule. The SiH functional chain extender can have an average chemical formula (III):

[Me₃SiO_{1/2}]_{m′}[HMe₂SiO_{1/2}]_{m″}[Me₂SiO_{2/2}]_{d′}[MeHSiO_{2/2}]_{d″} (III)

where Me refers to a methyl group, subscripts indicate the average number of the associated siloxane units in each molecule, subscript d′ has an average value in a range of 5 to 200 and can be 5 or more, 10 or more, 20 or more, 25 or more, 50 or more, 75 or more, 100 or more, even 150 or more while at the same time having a value of 200 or less, 175 or less, 150 or less, 125 or less, 100 or less, 75 or less, 50 or less, even 25 or less, and subscript d″ is 0 or one, provided the sum of m′ and m″ is 2, the sum of m″ and d″ is 2 so that the molecule has an average of 2 silyl-hydride groups.

The concentration of SiH functional chain extender in the first part pre-mixture, relative to combined weight of first and second parts, is 0.25 wt % or more and can be 0.5 wt % or more, 1.0 wt % or more, 1.5 wt % or more, 2.0 wt % or more, 2.5 wt % or more, 3.0 wt % or more, 3.5 wt % or more 4.0 wt %, or more, even 4.5 wt % or more while at the same time has an upper limit on concentration that depends on the degree of polymerization (DP) of the SiH functional chain extender. The upper limit on concentration when the DP is 100 or more is 5.0 wt % or less, and can be 4.5 wt % or less, 4.0 wt % or less, 3.5 wt % or less, 3.0 wt % or less, or even 2.5 wt % or less. The upper limit when the DP is less than 100 is less than 5.0 wt %, preferably 4.5 wt % or less, 4.0 wt % or less, 3.5 wt % or less, 3.0 wt % or less, even 2.5 wt % or less. Lower concentrations are required for small DP chain extenders because the resulting pre-polymer has less mobility or flexibility when the chain extender is short and can result in too much viscosity build in the first part if the concentration of the chain extender is too high.

The first part is prepared by combining the components of the first part pre-polymer, mixing them together and then allowing them to react to form a prepolymer by hydrosilylation reaction between the SiH groups of the SiH functional chain extender and the alkenyl groups of the alkenyl-functional linear polyorganosiloxanes and/or alkenyl-functional resinous polyorganosiloxanes. The hydrosilylation reaction can occur at 25 degrees Celsius (° C.) by allowing the pre-mixture to set for at least 24 hours. Alternatively, the hydrosilylation reaction can occur at a temperature higher than 25° C. and that can require less than 24 hours. Desirably, essentially all of the SiH groups of the chain extender react, but the alkenyl groups are in excess relative to the SiH groups so as to produce a prepolymer that has residual alkenyl groups. There is also expected to be unreacted alkenyl-functional linear polyorganosiloxanes and/or unreacted alkenyl-functional resinous polyorganosiloxanes in the first part as well as the alkenyl-functional prepolymer.

The second part of the two-part curable silicone composition comprises a linear alkenyl-functional polyorganosiloxane, a resinous alkenyl-functional polyorganosiloxane, a resinous SiH functional polyorganosiloxane crosslinker, and a hydrosilylation cure inhibitor. The second part is desirably free of linear polyorganosiloxanes having SiH functionality only on HMeSiO_{2/2} siloxane units.

The linear alkenyl-functional polyorganosiloxane in the second part is selected from those described for the first part and can be the same or different from the linear alkenyl-functional polyorganosiloxane of the first part. The concentration of alkenyl-functional linear polyorganosiloxane in the second part is typically 40 wt % or more, 45 wt % or more, 50 wt % or more, or even 55 wt % or more while at the same time is typically 60 wt % or less, 55 wt % or less 50 wt % or less, or even 45 wt % or less relative to the weight of the second part.

The resinous alkenyl-functional polyorganosiloxane in the second part is selected from those described for the first part and can be the same or different from the resinous alkenyl-functional polyorganosiloxane of the first part. The concentration of alkenyl-functional resinous polyorganosiloxane in the second part is typically 40 weight-percent (wt %) or more, 45 wt % or more, 50 wt % or more, or even 55 wt % or more while at the same time is typically 60 wt % or less, 55 wt % or less 50 wt % or less, or even 45 wt % or less relative to the combined weight of alkenyl-functional linear polyorganosiloxane and alkenyl-functional resinous polyorganosiloxanes in the second part.

The resinous SiH functional polyorganosiloxane crosslinker in the second part desirably is selected from one or more having an average chemical formula (IV):

(HMe₂SiO_{1/2})ₐ(Me₂SiO_{2/2})_{b}(SiO_{4/2})_{c}(HO_{1/2})_{d} (IV)

where:
Me refers to a methyl group;
subscripts indicate the average molar ratio of the associated siloxane unit in the molecule and wherein the sum of subscripts a, b, c and d desirably add up to 1.00;
subscript a typically has an average value of 0.01 or more, 0.02 or more, 0.03 or more, or even 0.04 or more while at the same time is typically 0.05 or less, and can be 0.04 or less, 0.03 or less, or even 0.02 or less;
subscript b typically has an average value of 0.50 or more, even 0.60 or more and typically has an average value of 0.70 or less, even 0.60 or less;
subscript c typically has an average value of 0.20 or more, even 0.30 or more and at the same time is typically 0.40 or less and can be 0.30 or less; and
subscript d has an average value of 0.00 or more, and can be 0.01 or more, 0.02 or more, 0.03 or more, even 0.04 or more while at the same time is typically 0.05 or less, 0.04 or less, 0.03 or less, 0.02 or less, or even 0.01 or less.

The concentration of resinous SiH functional crosslinker in the second part is sufficient to provide in a combination of equal weight-parts of the first part and second part a molar ratio of SiH functional groups to alkenyl groups (C═C groups)—a SiH/C═C ratio—that is 1.4 or less and that can be 1.3 or less, 1.26 or less, or even 1.2 or less while at the same time is desirably 1.0 or more, 1.1 or more, preferably 1.2 or more and can be 1.3 or more.

The concentration of the resinous SiH functional crosslinker in the second part can be, for example, 8 wt % or more, 9 wt % or more, 10 wt % or more, 11 wt % or more, 12 wt % or more, 13 wt % or more, 14 wt % or more, or even 15 wt % or more while at the same time can be 18 wt % or less, 17 wt % or less, 16 wt % or less, 15 wt % or less, 14 wt % or less, 13 wt % or less, 12 wt % or less, 11 wt % or less, even 10 wt % or less based on weight of the second part.

The weight-average molecular weight of the resinous SiH functional polyorganosiloxane crosslinker in the second part is typically 75 Daltons (Da) or more, 100 Da or more, 150 Da or more 200 Da or more, 250 Da or more, 300 Da or more, 400 Da or more, 450 Da or more, 500 Da or more, 550 Da or more, 600 Da or more, 650 Da or more, 700 Da or more, 750 Da or more, even 800 Da or more while at the same time is typically 850 Da or less, 840 Da or less, 830 Da or less, 820 Da or less, 815 Da or less, 810 Da or less, or even 800 Da or less.

The second part contains a hydrosilylation cure inhibitor. Hydrosilylation cure inhibitors can serve to provide storage stability by stabilizing the hydrosilylation reactants from premature curing. Examples of suitable cure inhibitors include any one or any combination of more than one of acetylene-type compounds such as 2-methyl-3-butyn-2-ol; 3-methyl-1-butyn-3-ol; 3,5-dimethyl-1-hexyn-3-ol; 2-phenyl-3-butyn-2-ol; 3-phenyl-1-butyn-3-ol; 1-ethynyl-1-cyclohexanol; 1,1-dimethyl-2-propynyl)oxy)trimethylsilane; and methyl(tris(1,1-dimethyl-2-propynyloxy))silane; ene-yne compounds such as 3-methyl-3-penten-1-yne and 3,5-dimethyl-3-hexen-1-yne; triazols such as benzotriazole; hydrazine-based compounds; phosphines-based compounds; mercaptane-based compounds; cycloalkenylsiloxanes including methylvinylcyclosiloxanes such as 1,3,5,7-tetramethyl-1,3,5,7-tetravinyl cyclotetrasiloxane and 1,3,5,7-tetramethyl-1,3,5,7-tetrahexenyl cyclotetrasiloxane.

The concentration of hydrosilylation cure inhibitor can be 0.01 wt % or more, 0.02 wt % or more, 0.03 wt % or more, 0.04 wt % or more, 0.05 wt % or more, 0.10 wt % or more, even 0.15 wt % or more while at the same time is typically 0.50 wt % or less, or even 0.30 wt % or less, 0.20 wt % or less, 0.1 wt % or less, 0.05 wt % or less, 0.01 wt % or less, with wt % relative to weight of the second part.

The concentration of hydrosilylation cure inhibitor is 0.01 wt % or more based on weight of the two-part curable silicone composition.

Use of the two-part curable silicone composition typically comprises mixing equal weight-parts of the first part and second part together and then allowing them to cure. Mixing equal weight-parts is not a requirement, but is ideal based on the compositional teachings herein. For example, mixing can also be done in weight-part ratios of 60:40, 55:45, 50:50, 45:55, 40:60 where ratios are weight parts first part: weight parts second part.

The present invention provides a moldable silicone composition that can rapidly cure by hydrosilylation at a temperature of 110° C. or less without requiring more than 6 weight-parts per million platinum from hydrosilylation catalysts based on composition weight or less than 0.1 wt % hydrosilylation inhibitor based on composition weight and that has a SiH/C═C ratio of less than 1.6.

### EXAMPLES

Table 1 provides information on the materials used for the samples described herein below.

TABLE 1

| Material | Description | Source |
|---|---|---|
| Alkenyl-functional | Dimethyl siloxane dimethylvinylsiloxane- | Available as |
| linear | terminated having an average chemical formula: | SILASTIC ™ |
| polyorganosiloxane | [ViMe₂SiO_{1/2}]₂[Me₂SiO_{2/2}]₄₉₃ | SFD-120 |
| A-1 | | Polymer from |
| | | The Dow |
| | | Chemical |
| | | Company. |
| Alkenyl-functional | Dimethylvinylated and trimethylvinylated silica | Prepare |
| resinous | having the following average chemical formula: | according to |
| polyorganosiloxane | [ViMe₂SiO_{1/2}]_{0.09}[Me₂SiO_{1/2}]_{0.42}[SiO_{4/2}]_{0.45}[HO_{1/2}]_{0.04} | teachings in |
| A-2 | having a weight-average molecular weight of | U.S. Pat. No. |
| | 3512 Da and 0.12 mol % vinyl content. | 2,676,182 as |
| | | a 72 wt % |
| | | solution in |
| | | xylenes. |
| Linear SiH | Dimethyl siloxane, hydrogen-terminated having an | Prepare |
| functional chain | average chemical formula: | according to |
| extender B-1a | [HMe₂SiO_{1/2}]₂[Me₂SiO_{2/2}]₂₀ | teachings in |
| | | U.S. Pat. No. |
| | | 5,310,843. |
| Linear SiH | Dimethyl siloxane, hydrogen-terminated having an | Prepare |
| functional chain | average chemical formula: | according to |
| extender B-1b | [Me₃SiO_{1/2}][HMe₂SiO_{1/2}][Me₂SiO_{2/2}]₂₅[HMeSiO_{2/2}] | teachings in |
| | | U.S. Pat. No. |
| | | 5,310,843. |
| Linear SiH | Dimethyl siloxane, hydrogen-terminated siloxane | Prepare |
| functional chain | having an average chemical formula: | according to |
| extender B-1c | [HMe₂O_{1/2}]₂[Me₂SiO_{2/2}]₇ | teachings in |
| | | U.S. Pat. No. |
| | | 5,310,843. |
| Linear SiH | Dimethyl siloxane, having an average chemical | Prepare |
| functional chain | formula: [Me₃SiO_{1/2}]2[Me₂SiO_{2/2}]₂₃[HMeSiO_{2/2}]₂ | according to |
| extender B-1d | | teachings in |
| | | U.S. Pat. No. |
| | | 5,310,843. |
| Linear SiH | Dimethyl siloxane, hydrogen terminated having an | Prepare |
| functional chain | average chemical formula: | according to |
| extender B-1e | [HMe₂O_{1/2}]₂[Me₂SiO_{2/2}]₁₁₈ | teachings in |
| | | U.S. Pat. No. |
| | | 5,310,843. |
| Hydrosilylation | Platinum 1,3-divinyl-1,1,3,3-tetramethyldisilioxane | Available from |
| catalyst | complex. | Sigma-Aldrich. |
| Resinous SiH | Average chemical formula: | Prepare |
| functional | [HMe₂SiO_{1/2}]_{0.02}[Me₂SiO_{1/2}]_{0.62}[SiO_{4/2}]_{0.30} having | according to |
| polyorganosiloxane | 0.95 mol % H and weight-average molecular weight | teachings in |
| crosslinker B-2 | of 809 Daltons. | U.S. Pat. No. |
| | | 4,774,310. |
| Linear SiH | Average chemical formula: | Prepare |
| functional | [Me₃SiO_{1/2}]₂[Me₂SiO_{2/2}]_{8.7}[HMeSiO_{2/2}]_{3.7} having | according to |
| polyorganosiloxane | 0.36 mol % H and a kinematic viscosity of 7.2 | teachings in |
| crosslinker B-3 | square millimeters/second (centiStokes). | U.S. Pat. No. |
| | | 3,722,247. |
| Hydrosilylation | 1-ethynyl-1-cyclohexanol | Available |
| cure inhibitor | | from Sigma |
| | | Aldrich. |

SILASTIC is a trademark of Dow Corning Corporation.

### Sample Preparation

Prepare two-part curable samples described in the following tables by forming separate First and Second parts. Prepare the first part by combining in the specified weight ratios the alkenyl-functional linear polyorganosiloxane A-1, alkenyl-functional resinous polyorganosiloxane A-2, and linear SiH functional chain extender B-1 components and then blending in the hydrosilylation catalyst component. Allow the mixture to cure at 25° C. for at least 24 hours to form prepolymer. Prepare the second part separately from the first part by blending the specified components together in the specified weight ratios.

### Sample Characterization

Characterize the cure time for the samples using the following moving die rheometer (MDR) test method.

### MDR Test Method

Use an Alpha Technologies Premier MDR-2000 device for testing. Place a 50 micrometer thick MYLAR™ film (MYLAR is a trademark of DUPONT Teijin Films US) on a weighing tray of a digital scale. Mix equal weight-parts of the two parts of a two-part curable silicone composition together at 3500 revolutions per minute for 30 seconds and immediately weight out approximately 4 grams of the mixed composition on to the MYLAR film. Cover the formulation with a second 50 micrometer thick MYLAR film and transfer the sample between MYLAR films immediately to MDR platens that are at a steady state temperature of 110° C. Close the platens against the MYLAR films to a thickness of approximately 0.5 millimeters and oscillate the bottom platen in a 1° arc throughout the test. Collect torque-modulus values every second for 10 minutes at 110° C. to obtain a plot of the torque-modulus as a function of time as the composition cures. Determine how long it takes for the composition to reach a torque-modulus of 1 deciNewton*meter (dNm). If a sample reaches one dNm torque-modulus in 60 seconds or less then it is considered to have a “fast cure” and passes the characterization. Longer times fail the characterization for failing to qualify as having a fast cure.

Formulations and results for the samples are in the following tables. Values for the components of each sample are reported in grams.

TABLE 2

| | Component | A | B | C | D | E | F | G | H | I | J |
|---|---|---|---|---|---|---|---|---|---|---|---|
| First | A-1 (g) | 49.95 | 44.95 | 44.95 | 44.95 | 49.95 | 49.95 | 47.45 | 49.45 | 47.45 | 47.45 |
| Part | A-2 (g) | 49.95 | 44.95 | 44.95 | 44.95 | 49.95 | 49.95 | 47.45 | 49.45 | 47.45 | 47.45 |
| | Chain | 0.00 | B-1c | B-1a | B-1b | 0.00 | 0.00 | B-1a | B-1b | B-1b | B-1a |
| | Extender (g) | | 10.00 | 10.00 | 10.00 | | | 5.00 | 1.00 | 5.00 | 5.00 |
| | Hydrosilylation | 0.1 | 0.1 | 0.1 | 0.1 | 0.1 | 0.1 | 0.1 | 0.1 | 0.1 | 0.1 |
| | Catalyst (g) | | | | | | | | | | |
| Second | A-1 (g) | 42.89 | 42.89 | 42.89 | 42.89 | 43.995 | 39.825 | 39.825 | 39.825 | 39.825 | 45.08 |
| Part | A-2 (g) | 42.89 | 42.89 | 42.89 | 42.89 | 43.995 | 39.825 | 39.825 | 39.825 | 39.825 | 45.08 |
| | B-2 (g) | 14.03 | 14.03 | 14.03 | 14.03 | 11.82 | 10.52 | 10.52 | 10.52 | 10.52 | 0.00 |
| | Hydrosilylation | 0.19 | 0.19 | 0.19 | 0.19 | 0.19 | 0.19 | 0.19 | 0.19 | 0.19 | 0.19 |
| | Cure Inhibitor (g) | | | | | | | | | | |
| | Chain Extender (g) | 0.00 | 0.00 | 0.00 | 0.00 | 0.00 | 0.00 | 0.00 | 0.00 | 0.00 | 0.00 |
| | B-3 | 0.00 | 0.00 | 0.00 | 0.00 | 0.00 | 9.64 | 9.64 | 9.64 | 9.64 | 9.65 |

| | | | | | | | | | | |
|---|---|---|---|---|---|---|---|---|---|---|
| SiH/C═C | 1.2 | 1.2 | 1.2 | 1.2 | 1.0 | 1.26 | 1.26 | 1.26 | 1.26 | 0.3 |
| ppm Pt from catalyst | 2.6 | 2.6 | 2.6 | 2.6 | 2.6 | 2.6 | 2.6 | 2.6 | 2.6 | 2.6 |
| Time to 1 dNm (s) | 73 | * | * | * | 67 | 126 | 84 | 93 | 110 | ** |
| Pass/Fail | Fail | Fail | Fail | Fail | Fail | Fail | Fail | Fail | Fail | Fail |

* First Part Gelled or became too viscous to mix with the second part.
** Did not Cure within 10 minutes.

TABLE 3

| | Component | 1 | 2 | 3 | 4 | 5 | 6 | 7 | 8 | 9 |
|---|---|---|---|---|---|---|---|---|---|---|
| First | A-1 (g) | 49.70 | 47.45 | 47.45 | 49.45 | 47.45 | 47.45 | 47.45 | 44.95 | 47.45 |
| Part | A-2 (g) | 49.70 | 47.45 | 47.45 | 49.45 | 47.45 | 47.45 | 47.45 | 44.95 | 47.45 |
| | Chain Extender | B-1c | B-1c | B-1a | B-1b | B-1b | B-1d | B-1e | B-1e | B-1a |
| | (g) | 0.50 | 5.00 | 5.00 | 1.00 | 5.00 | 5.00 | 5.00 | 10.00 | 5.00 |
| | Hydrosilylation | 0.1 | 0.1 | 0.1 | 0.1 | 0.1 | 0.1 | 0.1 | 0.1 | 0.1 |
| | Catalyst (g) | | | | | | | | | |
| Second | A-1 (g) | 42.89 | 42.89 | 42.89 | 42.89 | 42.89 | 42.89 | 42.89 | 42.89 | 43.995 |
| Part | A-2 (g) | 42.89 | 42.89 | 42.89 | 42.89 | 42.89 | 42.89 | 42.89 | 42.89 | 43.995 |
| | B-2 (g) | 14.03 | 14.03 | 14.03 | 11.82 | 14.03 | 14.03 | 14.03 | 14.03 | 11.82 |
| | Hydrosilylation | 0.19 | 0.19 | 0.19 | 0.19 | 0.19 | 0.19 | 0.19 | 0.19 | 0.19 |
| | Cure Inhibitor | | | | | | | | | |
| | Chain Extender | 0.00 | 0.00 | 0.00 | 0.00 | 0.00 | 0.00 | 0.00 | 0.00 | 0.00 |
| | (g) | | | | | | | | | |

| | | | | | | | | | |
|---|---|---|---|---|---|---|---|---|---|
| SiH/C═C | 1.2 | 1.2 | 1.2 | 1.2 | 1.2 | 1.2 | 1.2 | 1.2 | 1.0 |
| ppm Pt from catalyst | 2.6 | 2.6 | 2.6 | 2.6 | 2.6 | 2.6 | 2.6 | 2.6 | 2.6 |
| Time to 1 dNm (s) | 57 | 50 | 49 | 57 | 54 | 47 | 54 | 59 | 60 |
| Pass/Fail | Pass | Pass | Pass | Pass | Pass | Pass | Pass | Pass | Pass |

What is claimed is:

1. A two-part curable silicone composition comprising as separate parts:
(a) a first part comprising an alkenyl-functional prepolymer that is the hydrosilylation reaction product of a first part pre-mixture comprising:
i. a platinum hydrosilylation catalyst,
ii. alkenyl-functional linear polyorganosiloxanes,
iii. alkenyl-functional resinous polyorganosiloxanes and
iv. a linear SiH functional chain extender having an average of 2 SiH groups per molecule and being present at a concentration of 0.25 weight-percent or more and at the same time 5 weight-percent or less when having a DP of 100 or more and less than 5 weight-percent when having a DP of less than 100, with weight-percent relative to combined weight of first and second parts; and
(b) a second part comprising:
i. a linear alkenyl-functional polyorganosiloxane;
ii. a resinous alkenyl-functional polyorganosiloxane;
iii. a resinous SiH functional polyorganosiloxane crosslinker; and
iv. a hydrosilylation cure inhibitor;
wherein the alkenyl-functional and SiH functional components are present in the two-part curable silicone composition so as to provide a SiH/C═C ratio for the two-part curable silicone composition that is 1.4 or less; and
wherein the composition contains 6 weight part per million or less of platinum and 0.01 weight-percent or more hydrosilylation cure inhibitor, with concentrations based on the combined weight of the first and second parts.

2. The two-part curable silicone composition of claim 1, wherein the second part is free of linear polyorganosiloxanes having SiH functionality only on HMeSiO_{2/2} siloxane units.

3. The two-part curable silicone composition of claim 1, wherein the concentration of alkenyl-functional linear polyorganosiloxane in the first part pre-mixture is in a range of 40 to 60 weight-percent relative to combined weight of alkenyl-functional linear and resinous polyorganosiloxanes in the first part pre-mixture.

4. The two-part curable silicone composition of claim 1, wherein the concentration of alkenyl-functional linear polyorganosiloxane in the second part is in a range of 40 to 60 weight-percent relative to the weight of the second part.

5. The two-part curable silicone composition of claim 1, wherein the concentration of a resinous SiH functional polyorganosiloxane in the second part is in a range of 10 to 15 weight-percent based on weight of the second part.

6. The two-part curable silicone composition of claim 1, wherein the alkenyl-functional polyorganosiloxanes are vinyl functional polyorganosiloxanes.

7. The two-part curable silicone composition of claim 1, wherein:
(a) the alkenyl-functional linear polyorganosiloxane in the first part pre-mixture and the second part each has an average chemical composition (I):
[ViMe₂SiO_{1/2}]₂[Me₂SiO_{2/2}]_{d} (I)
where Vi refers to a vinyl group, Me refers to a methyl group, subscript d is the average number of Me₂SiO_{2/2} units in the molecule and has a value in a range of 450 to 550;
(b) the alkenyl-functional resinous polyorganosiloxane in the first and second parts each has an average chemical formula (II):
[ViMe₂SiO_{1/2}]_{m′}[Me₂SiO_{1/2}]ₘ[SiO_{4/2}]_{q}[HO_{1/2}]ₙ (II)
where Vi refers to a vinyl group, Me refers to a methyl group, subscripts refer to average mole-ratios of the associated group relative to all listed groups, m′ has a value in a range of 0.05 and 0.10, m has a value in a range of 0.40 and 0.50, q has a value in a range of 0.40 and 0.50, and n has a value in a range of 0.00 and 0.05.

8. The two-part curable silicone composition of claim 1, wherein, the chain extender has an average chemical formula (III):
[Me₃SiO_{1/2}]_{m′}[HMe₂SiO_{1/2}]_{m″}[Me₂SiO_{2/2}]_{d′}[MeHSiO_{2/2}]_{d″} (III)
where Me refers to a methyl group, subscripts indicate the average number of the associated siloxane units in each molecule, subscript d′ has an average value in a range of 5 to 200 and subscript d″ is 0 or one, provided the sum of m′ and m″ is 2, and the sum of m″ and d″ is 2 so that the molecule has an average of 2 silyl-hydride groups.

9. The two-part curable silicone composition of claim 1, wherein the resinous silyl-hydride functional polyorganosiloxane crosslinker has an average chemical formula (IV):
(HMe₂SiO_{1/2})ₐ(Me₂SiO_{2/2})_{b}(SiO_{4/2})_{c}(HO_{1/2})_{d} (IV)
where Me refers to a methyl group, subscripts indicate the average molar ratio of the associated siloxane unit in the molecule, subscript a has an average value in a range of 0.01 to 0.05, subscript b has an average value in a range of 0.50 to 0.70, subscript c has an average value in a range of 0.20 to 0.40, and subscript d has an average value of 0.00 to 0.05.

10. The two-part curable silicone composition of claim 1, wherein the two-part curable silicone composition has an average SiH/C═C is 1.0 or more and at the same time 1.26 or less.
